(19) United States
(12) Patent Application Publication
(10) Pub. No.: US 2011/0238370 A1
(43) Pub. Date: Sep. 29, 2011

(54) Methods, Apparatuses and Systems for Automatically Determining the State of a Cluster Tool

(76) Inventors: Johannes F. Beekman, Austin, TX (US); Lorn L. Christal, JR., Austin, TX (US); Diane K. Michelson, Austin, TX (US)

(21) Appl. No.: 12/749,169

(22) Filed: Mar. 29, 2010

(51) Int. Cl. G06F 15/00

(52) U.S. Cl. 702/182

(57) ABSTRACT

Methods, systems, and apparatuses are disclosed for determining the state of a cluster tool. In one embodiment, the method may include receiving status information for one or more modules of a cluster tool. The method may include defining one or more wafer flows through the cluster tool. Each wafer flow through the cluster tool may include one or more wafer flow steps performed by one or more modules. The method may include determining, with a processing device, the states of the one or more wafer flow steps in response to the status information. The method may include determining, with a processing device, the states of the one or more wafer flows in response to the state of the one or more wafer flow steps. The method may include determining the state of the cluster tool in response to the states of the one or more wafer flows.

### BACKGROUND OF THE INVENTION

1. Field of the Invention

This invention relates generally semiconductor fabrication. More particularly, but not by way of limitation, this invention relates to methods, apparatuses, and systems for determining the state of a cluster tool that may be used in semiconductor fabrication.

2. Description of the Related Art

Semiconductor device fabrication may require the use of semiconductor manufacturing tools. Some of these tools may be referred to as cluster tools, and each cluster tool may have several different modules. The different modules within a cluster tool may treat semiconductor wafers in the semiconductor manufacturing process. Depending on the configuration of a cluster tool, a wafer may take a single path or multiple paths through the modules of a cluster tool. Examples of multipath clusters tool platforms include the Endura platform available from Applied Materials, the Producer platform available from Applied Materials, the 2300 platform available from Lam Research, and the Lithius track platform available from Tokyo Electron.

The Semiconductor Equipment and Material Institute developed the E10 standard for determining the reliability, availability, and maintainability of a cluster tool and its modules. (Revision of SEMI E10-0304: Specification for Definition and Measurement of Equipment Reliability, Availability, and Maintainability (RAM), Jul. 16, 2008). Because of the complexity of multipath cluster tools, it is a challenge to accurately determine the reliability, availability, and maintainability of a multipath cluster tool. For example, “Automated State Estimation System for Cluster Tools and a Method of Operating the Same,” (U.S. Pat. No. 7,546,177) discloses methods using weighted entity states for representing the state of a cluster tool and measuring the reliability, availability, and maintainability of a cluster tool.

### SUMMARY OF THE INVENTION

Methods are disclosed for determining the state of a cluster tool. In one embodiment, the method may include receiving status information for one or more modules of a cluster tool. The method may further include defining one or more wafer flows through the cluster tool. Each wafer flow through the cluster tool may include one or more wafer flow steps performed by one or more modules. The method may further include determining, with a processing device, the states of the one or more wafer flow steps in response to the status information. The method may further include determining, with a processing device, the states of the one or more wafer flows in response to the state of the one or more wafer flow steps. The method may further include determining, with a processing device, the state of the cluster tool in response to the states of the one or more wafer flows.

In certain embodiments, the method may further include calculating the metrics for the cluster tool.

In certain embodiments, the method may be repeated in response to a change in the status information of one more modules in the cluster tool.

In certain embodiments, the one or more modules may be in a plurality of different states.

In certain embodiments, defining the one or more wafer flows through the cluster tool may include defining a wafer flow corresponding to a wafer flow recipe.

In certain embodiments, determining the states of the one or more wafer flow steps in response to the status information may include comparing the states of the one or more wafer flow modules with a module state order table.

In certain embodiments, determining the states of the one or more wafer flows may include comparing the states of the one or more wafer flow steps with a step state order table.

In certain embodiments, determining the states of the one or more wafer flows further may include selectively limiting the available wafer flow states.

In certain embodiments, determining the state of the cluster tool in response to the states of the one or more wafer flows may include comparing the states of the one or more wafer flows with a wafer flow state order table.

In certain embodiments, determining the state of the cluster tool in response to the states of the one or more wafer flows may further include prioritizing the wafer flows.

A computer program product is also disclosed. The computer program product tangibly embodies computer readable instructions that, when executed by a computer, cause the computer to perform operations. In one embodiment, the computer program product may receive status information for one or more modules of a cluster tool. In certain embodiments, the computer program product may define one or more wafer flows through the cluster tool. Each defined wafer flow may include one or more wafer flow steps performed by the one or more modules. In certain embodiments, the computer program product may determine the states of the one or more wafer flow steps in response to the status information. In certain embodiments, the computer program product may determine the states of the one or more wafer flows in response to the state of the one or more wafer flow steps. In certain embodiments, the computer program product may determine the state of the cluster tool in response to the states of the one or more wafer flows.

In certain embodiments, the computer program product's operations may further include calculating metrics for the cluster tool.

In certain embodiments, the computer program product may repeat the operation in response to a change in the status information of the one or more modules in the cluster tool.

In certain embodiments of the computer program product, the one or more modules may be in a plurality of different states.

In certain embodiments of the computer program product, defining the one or more wafer flows through the cluster tool may include defining a wafer flow corresponding to a wafer flow recipe.

In certain embodiments of the computer program product, determining the states of the one or more wafer flow steps in response to the status information may include comparing the states of the one or more wafer flow modules with a module state order table.

In certain embodiments of the computer program product, determining the states of the one or more wafer flows may include comparing the states of the one or more wafer flow steps with a step state order table.

In certain embodiments of the computer program product, determining the states of the one or more wafer flows further may include selectively limiting the available wafer flow states.

In certain embodiments of the computer program product, determining the state of the cluster tool in response to the states of the one or more wafer flows may include comparing the states of the one or more wafer flows with a wafer flow state order table.

In certain embodiments of the computer program product, determining the state of the cluster tool in response to the states of the one or more wafer flows may further include prioritizing the wafer flows.

Apparatuses are also disclosed. In one embodiment, the apparatus may include an input interface specifically configured to receive status information for one or more cluster tool modules in a cluster tool. In certain embodiments, the apparatus may include a memory device configured to store one or more wafer flows through the cluster tool. Each stored wafer flow may include one or more wafer flow steps performed by the one or more cluster tool modules. In certain embodiments, the apparatus may include a processing device configured to determine the states of the one or more wafer flow steps in response to the status information, determine the states of the one or more wafer flows in response to the state of the one or more wafer flow steps, and determine the state of the cluster tool in response to the states of the one or more wafer flows.

Systems are also disclosed. In one embodiment, the system includes a cluster tool comprising one or more modules. In certain embodiments, the system may include a computer system coupled to the cluster tool. The computer system may include an input interface specifically configured to receive status information for one or more cluster tool modules in a cluster tool. The computer system may further include a memory device configured to store one or more wafer flows through the cluster tool. Each stored wafer flow may include one or more wafer flow steps performed by the one or more cluster tool modules. The computer system may further include a processing device configured to determine the states of the one or more wafer flow steps in response to the status information, determine the states of the one or more wafer flows in response to the state of the one or more wafer flow steps, and determine the state of the cluster tool in response to the states of the one or more wafer flows.

The term “wafer flow” is defined as the module path a wafer takes through a cluster tool during the semiconductor fabrication process.

The term “wafer flow recipe” may generally be define the various wafer processing steps to be performed by the modules.

The term “wafer flow step” is defined as discrete part of a wafer flow.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram of one embodiment of a cluster tool.

FIG. 2 is a schematic flow chart diagram illustrating one embodiment of a method for calculating metrics for a cluster tool.

FIG. 3 illustrates one example of status information of modules in a cluster tool.

FIG. 4 illustrates examples of four different wafer flows.

FIG. 5 illustrates one example of comparing the states of two wafer flow modules with a module state order table.

FIG. 6 illustrates one example of comparing the states of three wafer flow steps with a step state order table.

FIG. 7A illustrates one example of selectively limiting the wafer flow states within three wafer flows.

FIG. 7B illustrates a second example of selectively limiting the wafer flow states within three wafer flows.

FIG. 7C illustrates a third example of selectively limiting the wafer flow states within three wafer flows.

FIG. 8A illustrates one example of comparing the states of two wafer flows using a wafer flow state order table.

FIG. 8B illustrates a second example of comparing the states of two wafer flows using a wafer flow state order table.

FIG. 9 is a schematic diagram illustrating one embodiment of a computer program product that may be used in accordance with certain embodiments of the disclosed methods.

FIG. 10 is a schematic block diagram illustrating one embodiment of a system for determine the state of a cluster tool.

### DETAILED DESCRIPTION

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

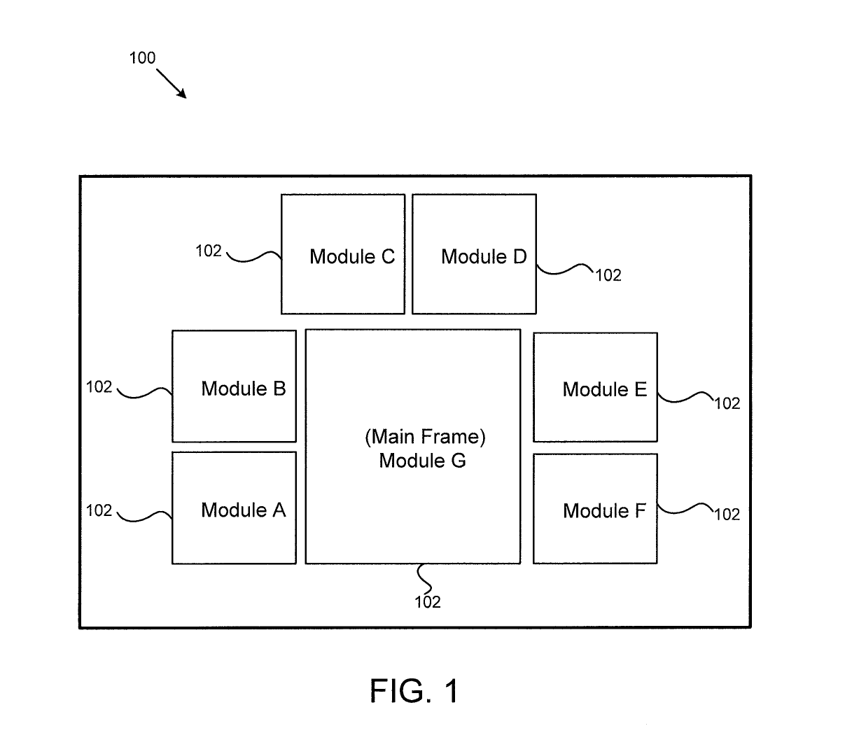

FIG. 1 illustrates one embodiment of a cluster tool 100. Cluster tool 100 may be used in the fabrication of semiconductor devices. The cluster tool 100 may include several modules 102. For example, modules 102 found in cluster tool 100 may include a chemical vapor deposition chamber, a physical vapor deposition chamber, a cool-down chamber, and an atomic layer deposition chamber.

A module 102 on a cluster tool 100 may be in a plurality of states. The plurality of states may include for example one state, two states, four states, six states, or N states. In certain embodiments, a module 102 may be in one of two states. These two states may be “up” or “down.” A module 102 in an “up” state may be characterized as functioning. A module 102 in a “down” state may be characterized as non-functioning. Alternatively, the modules 102 may be in one of six states. Under the E10 standard, these six states may include Productive (PRD), Engineering (ENG), Standby (SBY), Unscheduled downtime (UDT), Scheduled Downtime (SDT), and Non-Scheduled state (NST). A module 102 in a PRD state may be characterized as function productively. A module 102 in an ENG state may be characterized as being in a testing state. A module 102 in an SBY state may be characterized as being in a standby state. A module 102 in a UDT state may be characterized as being unexpectedly down. A module 102 in an SDT state may be undergoing scheduled routine maintenance. A module 102 in an NST state is not scheduled to be used for anything. Collectively, the PRD, ENG, and SBY states may be characterized as “up” states where the module 102 is in a condition to perform its intended function. Collectively, the UDT and SDT states may be characterized as being in a “down” state where the module 102 is not in a condition to perform its intended function.

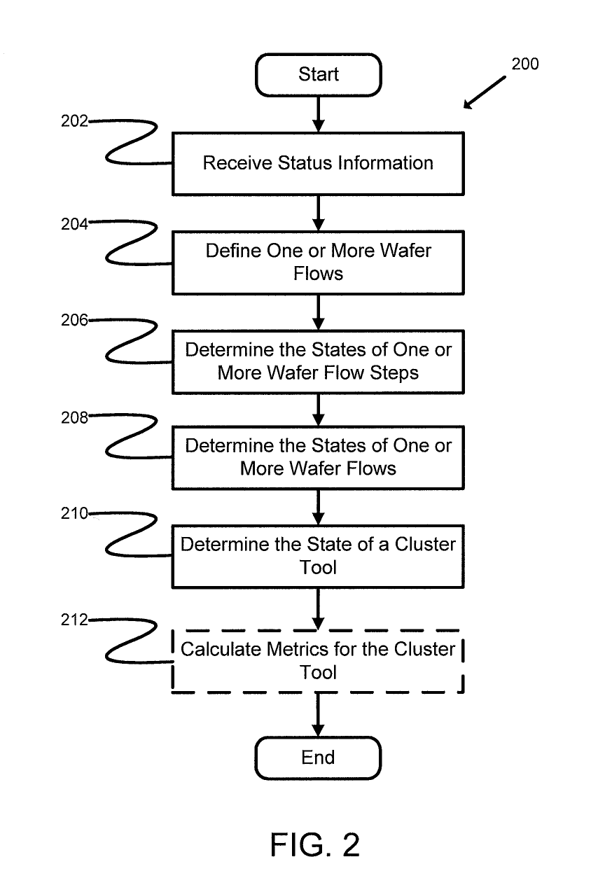

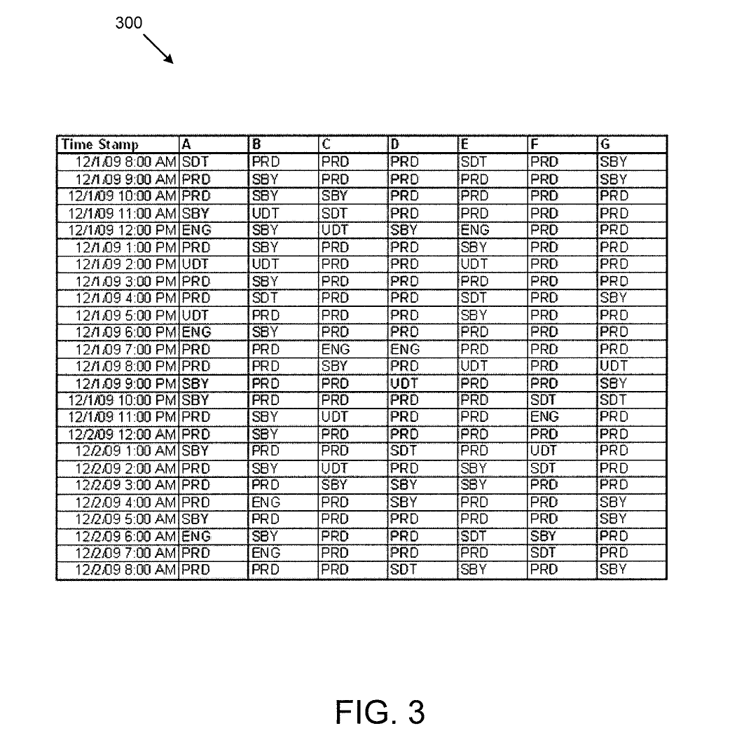

FIG. 2 illustrates one embodiment of a method 200 of determining the state of a cluster tool, such as an embodiment of cluster tool 100. The method 200 may include receiving 202 status information of one or more modules 102 of a cluster tool 100. FIG. 3 illustrates one embodiment of status information 300 that may be received from the one or more modules 102. Status information 300 may include the state of a module 102. In certain embodiments, status information 300 may also include the time a module 102 was in a given state. In certain embodiments, the time a module 102 is in a given state may be represented by a time stamp. As shown in FIG. 3, status information 300 for 7 modules 102 (A, B, C, D, E, F, and G) is represented for 25 different time values. In certain embodiments, status information 300 for one or more modules 102 is received each time the state of any of the one or more modules 102 changes. The status information 300 may be provided automatically from the modules 102, input manually by a user, or downloaded from a database (not shown).

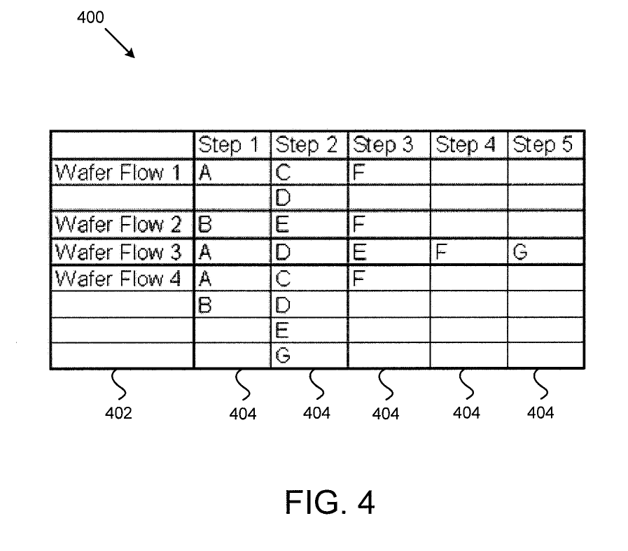

The method 200 may further include defining 204 one or more wafer flows 402 through the cluster tool 100. Each wafer flow 402 through the cluster tool 100 may include one or more wafer flow steps 404 performed by one or more modules 102. FIG. 4 illustrates four different examples of possible wafer flows 402 defined in a cluster tool 100. For example, wafer flow 1 is defined 204 with three different steps 404. In the first step 404, a wafer may be processed by module A. In the second step 404, a wafer may be processed by modules C or D. In the third step 404, a wafer may be processed in module F. Similarly, wafer flow 2 is defined 204 with three steps 404. In the first step 404, a wafer may be processed by module B. In the second step 404, a wafer may be processed by module E. In the third step 404, the module may be processed by module F. Wafer flow 3 and wafer flow 4 illustrate two similar examples of wafer flows 402 defined 204 with 5 steps 404 and 3 steps 404, respectively.

A cluster tool 100 may have several defined wafer flows 402. For example, one embodiment of cluster tool 100 may have hundreds of wafer flows 402. In certain embodiments, defining 204 the one or more wafer flows 402 through the cluster tool 100 may include defining 204 a wafer flow 402 corresponding to a wafer flow recipe. In these embodiments, multiple wafer flows 402 may use the same modules 102 in the same steps 404, but each unique recipe may utilize the modules 102 in different ways. In other embodiments, a wafer flow 402 may be defined as containing all of the recipes that use the same modules 102 in the same steps 404.

In certain embodiments, the method 200 may further include determining 206, with a processing device, the states of the one or more wafer flows steps 404 in response to the status information 300. In certain embodiments, the state of a wafer flow steps 404 may correspond to the state of the modules 102. For example, the state of step 1 of wafer flow 1 in FIG. 4 may correspond to the state of module A. Moreover, if module A is in a PRD state, then step 1 of wafer flow 1 may be characterized as being in a PRD state.

In certain embodiments, determining 206 the states of the one or more wafer flow steps 404 may include comparing the states of the one or more wafer flow modules 102 with a module state order table 502, 504. For example, the state of step 2 in wafer flow 1 in FIG. 4 may correspond to the states of modules C or D. In this example, the states of modules C and D may be compared to determine 206 the state of the wafer flow step 404. In certain embodiments, the states of a modules 102 may be compared using a module state order table 502, 504. In certain embodiments, the step 404 may be assigned the highest state value resulting from the comparison of the states of the modules 102. In certain embodiments, the module state order table 502, 504 may rank the states in any order. In certain embodiments, the module state order table 502, 504 may rank the states characterizing modules 102 performing their intended function ahead of the states characterizing modules 102 not performing their intended function. In certain embodiments, the module state order stable 502, 504 may rank the “up” states at a higher priority than the “down” states. In certain embodiments with 6 states, for example, the module state order table may use the following rank order of states: PRD, ENG, SBY, UDT, SDT, NST.

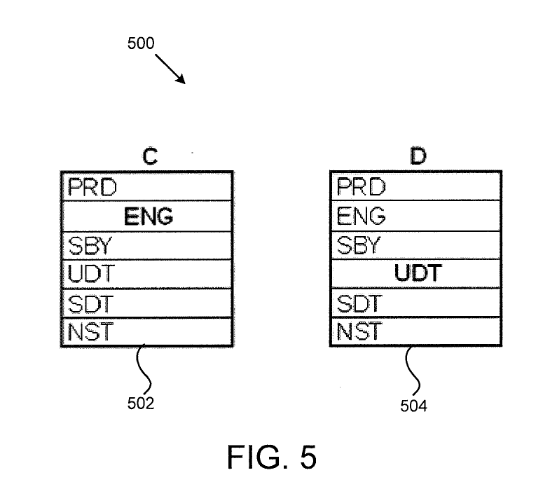

FIG. 5 illustrates one embodiment of a comparison 500 using module state order tables 502, 504. In this example, module state order table 502 may represent module C in step 2 of wafer flow 1 in FIG. 4, and module state order table 504 may represent module D in step 2 of wafer flow 2 in FIG. 4. As shown in FIG. 5, the state of module C is ENG, and the state of module D is UDT. As shown in these example module state order tables 502, 504 in FIG. 5, ENG is a higher state than UDT, and thus the highest state value resulting from the comparison 500 of modules C and modules D using a module state order tables 502, 504 is ENG. In this example, the wafer flow step 404 may be assigned the ENG state.

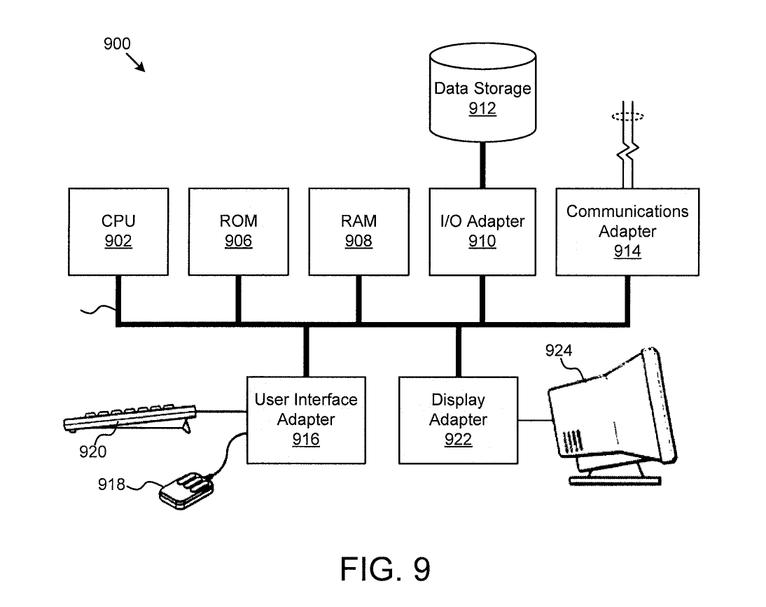

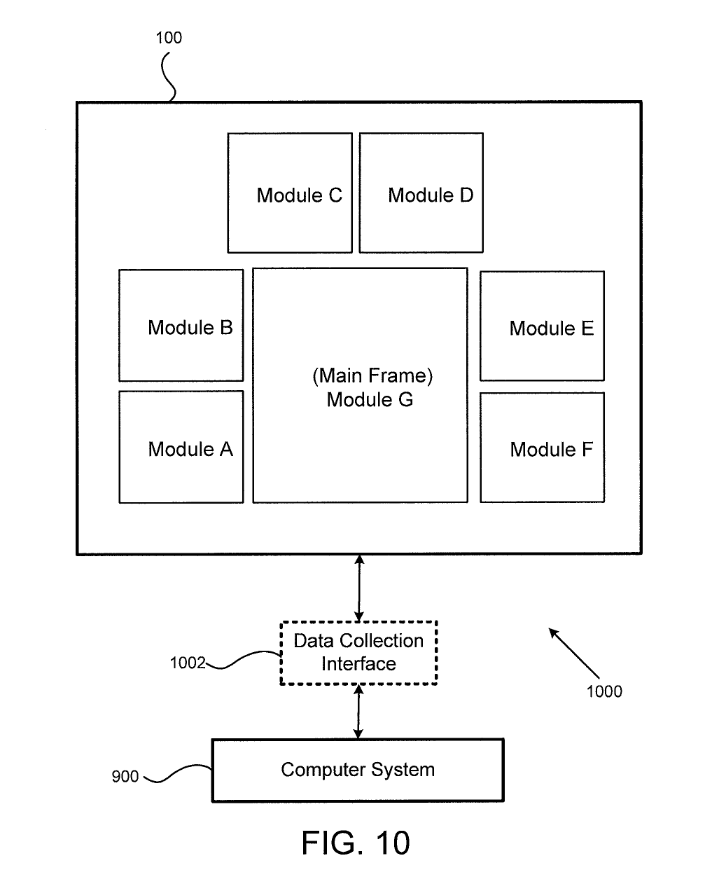

The method 200 may further include determining 208, with a processing device, the states of one or more wafer flows 402 in response to the state of the one or more wafer flow steps 404. Embodiments of a processing device are described in more detail below with reference to FIG. 9. In certain embodiments, the states of the wafer flow steps 404 may be compared using a step state order table 602, 604, 606. In certain embodiments, the wafer flow 402 may be assigned the highest state value resulting from the comparison of the states of the wafer flow steps 404. In certain embodiments, the step state order table 602, 604, 606 may rank the states in any order. In certain embodiments, the step state order table 602, 604, 606 may rank the states characterizing wafer flow steps 404 not performing their intended function ahead of states that characterize wafer flow step 404 as performing their intended function. In certain embodiments, the step state order stable 602, 604, 606 may rank the “down” states at a higher priority than the “up” states. In certain embodiments with 6 states, the module state order table may use the following rank order of states: NST, UDT, SDT, PRD, ENG, SBY.

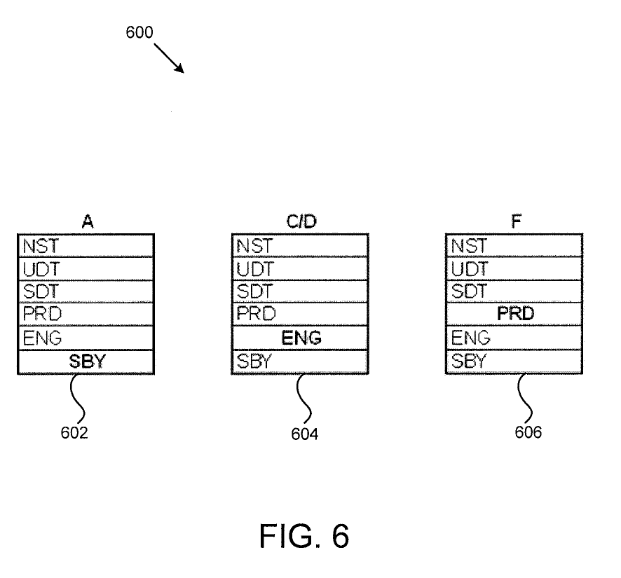

FIG. 6 illustrates one embodiment of a comparison 600 using step state order tables 602, 604,606. In this example, step state order table 602 may represent step 1 of wafer flow 1 in FIG. 4, step state order table 602 may represent step 2 of wafer flow 1 in FIG. 4, and step state order stable 606 may represent step 3 of wafer flow 1 in FIG. 4. As shown in FIG. 6, the state of step 1 is SBY, the state of step 2 is ENG, and the state of step 3 is PRD. As shown in these example step state order tables 602, 604, 606 in FIG. 6, PRD is a higher state than ENG or SBY, and thus the highest state value resulting from the comparison of steps 1, 2, and 3 using a step state order tables 602, 604, 606 is PRD. In this example, wafer flow 1 may be assigned the PRD state.

In certain embodiments, when determining 208 the states of one or more wafer flows 402 in response to the state of the one or more wafer flow steps, the available wafer flow states are selectively limited. In some embodiments, selectively limiting the available wafer flow states may be referred to as a wafer flow switch. Using a wafer flow switch may allow a more accurate representation of the states of the one or more wafer flows 402.

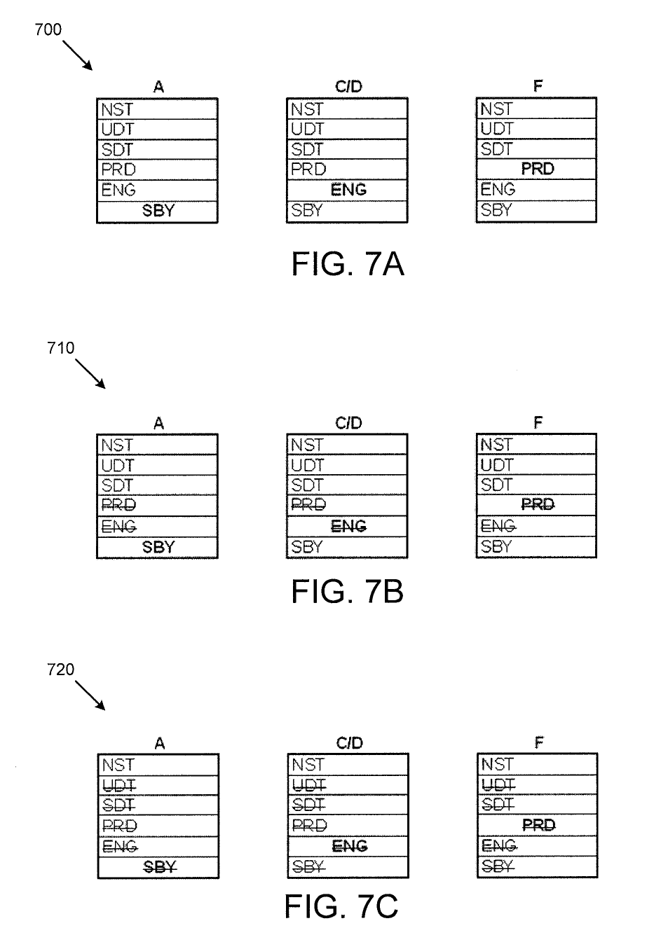

In certain embodiments, a wafer flow 402 may be characterized as being ON. In certain embodiments, a wafer flow 402 characterized as ON may be in any available state in the step state order table 602. FIG. 7A illustrates one example of a step state order comparison 700 in which wafer flow 1 is characterized as being ON. As shown in FIG. 7A, each of the states are available, and the state of wafer flow 1 may be characterized as PRD.

In certain embodiments, a wafer flow 402 may be characterized as being OFF. In certain embodiments, a wafer flow 402 characterized as OFF may be in all states but the “up” states. In certain embodiments with 6 states, a wafer flow 402 may be in all states except for PRD and ENG. FIG. 7B illustrates one example of a step state order comparison 710 in which wafer flow 1 is characterized as being OFF. As shown in FIG. 7B, each of the states are available except for PRD and ENG. Thus, the highest available state left after the step state order comparison 710 is SBY.

In certain embodiments, a wafer flow 402 may be characterized as being NST. In certain embodiments, a wafer flow 402 may only be in the NST state. FIG. 7C illustrates one example of a step state order comparison 720 in which wafer flow 1 is characterized as being NST. As shown in FIG. 7C, the only state available is NST. Thus, the highest available state left after the step state order comparison 720 is NST.

FIGS. 7A, 7B, and 7C show three examples of implementing a wafer flow switch. These examples are not meant to be limiting, but are simply used to demonstrate 3 ways of selectively limiting the available wafer flow states using a wafer flow switch. Several other types of wafer flow switches may be developed by one of skill in the art.

In certain embodiments, the method 200 may further include determining 210, with a processing device, the states of the cluster tool 100 in response to the states of the one or more wafer flows 402. In certain embodiments, determining 210 the states of the cluster tool 100 may include comparing the states of the one or more wafer flows 402 with a wafer flow state order table 802, 804. In certain embodiments, the cluster tool 100 may be assigned the highest state value resulting from the comparison of the states of the wafer flows 402. In certain embodiments, the wafer flow state order table 802, 804 may rank the states in any order. In certain embodiments, the wafer flow state order table 802, 804 may rank the states characterizing wafer flow as performing its intended function ahead the states characterizing a wafer flow as not performing its intended function. In certain embodiments, the module state order stable 802, 804 may rank the “up” states at a higher priority than the “down” states. In certain embodiments with 6 states, the wafer flow state order table 802, 804 may use the following rank order of states: PRD, UDT, SDT, ENG, SBY, NST.

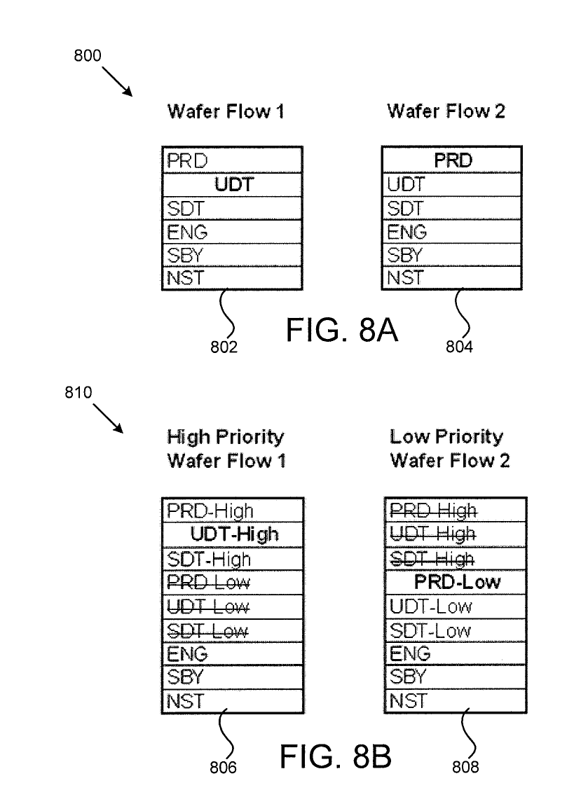

FIG. 8A illustrates one embodiment of a comparison 800 using wafer flow state order table 802, 804. In this example, wafer flow state order table 802 may represent wafer flow 1 in FIG. 4, and wafer flow state order stable 804 may represent wafer flow 2 in FIG. 4. (Wafer flows 3 and 4 are omitted from this example for simplicity). As shown in FIG. 8A, the state of wafer flow 1 is UDT and the state of wafer flow 2 is PRD. As shown in these example wafer flow state order tables 802, 804 in FIG. 8A, PRD is a higher state than UDT, and thus the highest state value resulting from the comparison of wafer flows 1 and 2 using wafer flow state order tables 802, 804 is PRD. In this example, the cluster tool 100 may be assigned the PRD state.

In certain embodiments, determining 210 the state of the cluster tool 100 in response to the states of the one or more wafer flows 402 includes prioritizing the wafer flows. As discussed earlier, a cluster tool 100 may have 100 different wafer flows 402. These wafer flows 402 may include production runs or test wafer flows. In certain embodiments, in determining 210 the state of the cluster tool, the state of wafer flows 402 running production wafer flows may be prioritized higher than test wafer flows. In certain embodiments, a cluster tool may have a plurality of high priority wafer flows and a plurality of low priority wafer flows. In certain embodiments, a cluster tool may have plurality of wafer flows 402 at different priorities. In certain embodiments, comparing prioritized wafer flows 402 includes using an advanced wafer flow state order table 806, 808. An advanced wafer flow state order table 806, 808 reflects the prioritization of the different wafer flow states in the state order table. In the advanced wafer flow state order table 806, 808 the high priority wafer flow states may be ranked higher than the low priority wafer flow states.

FIG. 8B illustrates one embodiment of a comparison 810 using an advanced wafer flow state order table 806, 808. In this example, advanced wafer flow state order table 806 represents wafer flow 1 (a high priority wafer flow), and advanced wafer flow state order stable 808 represents wafer flow 2 (a low priority wafer flow). (Wafer flows 3 and 4 are omitted from this example for simplicity). As shown in FIG. 8B, each wafer flow priority level may use its own advanced wafer flow state order table 806, 808. As shown in FIG. 8B, the state of wafer flow 1 is UDT-High and the state of wafer flow 2 is PRD-Low. As shown in these example advanced wafer flow state order tables 806, 808 in FIG. 8B, UDT-high is a higher state than PRD-Low, and thus the highest state value resulting from the comparison of wafer flows 1 and 2 using wafer flow state order tables 802, 804 is UDT-High. In this example, the cluster tool 100 may be assigned the UDT state. In this example, the state of the cluster tool 100 is different than the state of the cluster tool when wafer priority was not used. Moreover, in this example, even though the state of the low priority wafer flow is PRD, the state of the high priority wafer flow more accurately characterizes the state of the cluster tool.

In certain embodiments, the method 200 is repeated in response to a change in the status information 200 of the one or more modules 102 in the cluster tool 100. In certain embodiments, method steps 202, 204, 206, 208, and 210 may result in the determination of the state of a cluster tool 100 at the time stamp of the status information 300. In certain embodiments, if any of the modules 102 in a cluster tool 100 changes status, updated status information 200 may be provided 202. In response to this change, the method steps 204, 206, 208, and 210 to are then may be repeated to determine the state of a cluster tool 100 with new status information 300. In certain embodiments, the state of the cluster tool 100 may be determined each time the modules 102 changes state. In certain embodiments, all of the state status information for the modules 102 of a cluster tool 100 may be provided 202 as represented in FIG. 2, and the method steps 204, 206, 208, and 210 may be repeated for each row of the table of status information 300. For example, status information 300 provides 25 instances of the state of each module 102 in cluster tool 100 and the time each module 102 is in a given state. The steps of method 200 may be repeated 25 times to calculate the state of the cluster tool 100 for each instance of the status information 300.

In certain embodiments, the method 200 also includes calculating 212 metrics for the cluster tool. Reliability, availability, and maintainability metrics may be calculated for the cluster tool 100 in response the state of the cluster tool 100 and the time the cluster tool 100 was in that state. These metrics may include but are not limited to: the total time the cluster tool 100 was in a given state and the percentage of the total time that a cluster tool 100 was in a given state. For example, in a six-state cluster tool, the following metrics may be calculated: Total Operational Production Time Total Operational Standby Time, Total Operational Engineering Time, Total Scheduled Downtime, Total Unscheduled Downtime, Total Non Scheduled Time, Total Operational Time, Total Time, Total Operational Production Time (%), Total Operational Standby Time (%), Total Operational Engineering Time (%), Total Scheduled Downtime (%), Total Unscheduled Downtime (%).

A computer program product may perform the steps of method 200. Moreover, the computer program product may include a stand alone box, a compact disc, a DVD, a flash storage drive, an optical storage drive, or a like device. The computer program product may be run on a stand alone computer systems 900 such as a personal computer, PDA, server, or workstation. The discussion below presents certain embodiments of a computer system 900.

FIG. 9 illustrates a computer system 900 for determining the state of a cluster tool 100. The central processing unit (CPU) 902 is coupled to the system bus 904. The CPU 902 may be a general purpose CPU or microprocessor. The present embodiments are not restricted by the architecture of the CPU 902, so long as the CPU 902 supports the operations as described herein. The CPU 902 may execute the various logical instructions according to the present embodiments. For example, the CPU 902 may execute machine-level instructions according to the exemplary operations described above with reference to FIG. 2.

The computer system 900 also may include Random Access Memory (RAM) 908, which may be SRAM, DRAM, SDRAM, or the like. The computer system 900 may utilize RAM 908 to store the various data structures—such as wafer flow 402 definitions—used by a software application configured to determine the state of a cluster tool 100. The computer system 900 may also include Read Only Memory (ROM) 906 which may be PROM, EPROM, EEPROM, optical storage, or the like. The ROM may store configuration information for booting the computer system 900.

The computer system 900 may also include an input/output (I/O) adapter 910, a communications adapter 914, a user interface adapter 916, and a display adapter 922. The I/O adapter 210 and/or user the interface adapter 916 may, in certain embodiments, enable a user to interact with the computer system 900 in order to input information for status information 300, wafer flow priority, or wafer flow switches. In a further embodiment, the display adapter 922 may display a graphical user interface associated with a software or web-based application for displaying the state of a cluster tool 100. The graphical user interface may include a spreadsheet or a computer program with corresponding code in Java, C++, C#, C, .NET or other like programming languages.

The I/O adapter 910 may connect to one or more storage devices 912, such as one or more of a hard drive, a Compact Disk (CD) drive, a floppy disk drive, a tape drive, to the computer system 900. The communications adapter 914 may be adapted to couple the computer system 900 to the network 106, which may be one or more of a LAN and/or WAN, and/or the Internet. The user interface adapter 916 couples user input devices, such as a keyboard 920 and a pointing device 918, to the computer system 900. The display adapter 922 may be driven by the CPU 902 to control the display on the display device 924.

The present embodiments are not limited to the architecture of system 900. Rather the computer system 900 is provided as an example of one type of computing device that may be adapted. For example, any suitable processor-based device may be utilized including without limitation, including personal data assistants (PDAs), and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

FIG. 9 illustrates an embodiment of a system 1000 for determining the state of a cluster tool 100. In certain embodiments, the system 1000 may include a cluster tool 100 with one or more modules 102 as described above. In certain embodiments, the system may also include the computer system 900 coupled to the cluster tool. In certain embodiments, the cluster tool 100 may be coupled to the computer system 900 through the communications adapter 914. In certain embodiments, the system 1000 optionally includes a data collection interface 1002. The data collection interface may be coupled to both the cluster tool 100 and the computer system 900. In certain embodiments, the data collection interface 1002 may act to collect status information 300 from the modules of the cluster tool.

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept should be apparent to those skilled in the art from this disclosure.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method, comprising:
receiving status information for one or more modules of a cluster tool;
defining one or more wafer flows through the cluster tool, each wafer flow comprising one or more wafer flow steps performed by the one or more modules;
determining, with a processing device, the states of the one or more wafer flow steps in response to the status information;
determining, with a processing device, the states of the one or more wafer flows in response to the state of the one or more wafer flow steps; and
determining, with a processing device, the state of the cluster tool in response to the states of the one or more wafer flows.

2. The method of claim 1, further comprising calculating metrics for the cluster tool.

3. The method of claim 1, wherein the steps of claim 1 are repeated in response to a change in the status information of the one or more modules in the cluster tool.

4. The method of claim 1, wherein the one or more modules can be in a plurality of different states.

5. The method of claim 1, wherein defining the one or more wafer flows through the cluster tool comprises defining a wafer flow corresponding to a wafer flow recipe.

6. The method of claim 1, wherein determining the states of the one or more wafer flow steps in response to the status information comprises comparing the states of the one or more wafer flow modules with a module state order table.

7. The method of claim 1, wherein determining the states of the one or more wafer flows comprises comparing the states of the one or more wafer flow steps with a step state order table.

8. The method of claim 7, wherein determining the states of the one or more wafer flows further comprises selectively limiting the available wafer flow states.

9. The method of claim 1, wherein determining the state of the cluster tool in response to the states of the one or more wafer flows comprises comparing the states of the one or more wafer flows with a wafer flow state order table.

10. The method of claim 9, wherein determining the state of the cluster tool in response to the states of the one or more wafer flows further comprises prioritizing the wafer flows.

11. A computer program product tangibly embodying computer readable instructions that, when executed by a computer, cause the computer to perform operations comprising:
receiving status information for one or more modules of a cluster tool;
defining one or more wafer flows through the cluster tool, each wafer flow comprising one or more wafer flow steps performed by the one or more modules;
determining the states of the one or more wafer flow steps in response to the status information;
determining the states of the one or more wafer flows in response to the state of the one or more wafer flow steps; and
determining the state of the cluster tool in response to the states of the one or more wafer flows.

12. The computer program product of claim 11, the operations further comprising calculating metrics for the cluster tool.

13. The computer program product of claim 11, wherein the operations of claim 10 are repeated in response to a change in the status information of the one or more modules in the cluster tool.

14. The computer program product of claim 11, wherein the one or more modules can be in a plurality of different states.

15. The computer program product of claim 11, wherein defining the one or more wafer flows through the cluster tool comprises defining a wafer flow corresponding to a wafer flow recipe.

16. The computer program product of claim 11, wherein determining the states of the one or more wafer flow steps in response to the status information comprises comparing the states of the one or more wafer flow modules with a module state order table.

17. The computer program product of claim 11, wherein determining the states of the one or more wafer flows comprises comparing the states of the one or more wafer flow steps with a step state order table.

18. The computer program product of claim 17, wherein determining the states of the one or more wafer flows further comprises selectively limiting the available wafer flow states.

19. The computer program product of claim 11, wherein determining the state of the cluster tool in response to the states of the one or more wafer flows comprises comparing the states of the one or more wafer flows with a wafer flow state order table.

20. The computer program product of claim 19, wherein determining the state of the cluster tool in response to the states of the one or more wafer flows further comprises prioritizing the wafer flows.
